(19) United States
(12) Patent Application Publication
(10) Pub. No.: US 2013/0326881 A1
(43) Pub. Date: Dec. 12, 2013

(54) Cartridge Restoring Device With Fluid Delivery

(71) Applicant: Eveready Battery Company Inc., St Louis, MO (US)

(72) Inventor: Alan Blatter, (US)

(21) Appl. No.: 13/909,204

(22) Filed: Jun. 4, 2013

Related U.S. Application Data
(60) Provisional application No. 61/656,068, filed on Jun. 6, 2012.

(51) Int. Cl. B26B 21/44

(52) U.S. Cl. CPC B26B 21/446
USPC 30/41

(57) ABSTRACT

A safety razor includes a handle adapted to support a razor cartridge and a razor cartridge mounted to the handle. The razor cartridge includes a reservoir assembly and a cartridge assembly that defines a shave plane and is adapted to move with relation to the reservoir assembly during normal shaving operation. A delivery channel connects the reservoir assembly to the cartridge assembly. The reservoir assembly adapted to contain a non-solid shaving aid. The delivery channel is adapted to allow the non-solid shaving aid to flow between the reservoir assembly and the cartridge assembly during normal shaving operation. The delivery channel is further adapted to undergo an internal volume change that creates a pumping action as the cartridge assembly pivots with relation to the reservoir assembly during normal shaving operation.

### CROSS REFERENCE TO RELATED APPLICATIONS

This application claims the benefit of U.S. Provisional Patent Application Ser. No. 61/656,068, filed Jun. 6, 2012, incorporated herein in its entirety for reference.

### BACKGROUND

1. Field of the Present Disclosure

The present disclosure is generally directed to shaving implements, specifically safety razors that store and dispense a non-solid shaving aid during use.

2. Background

Many modern safety razors include a disposable razor cartridge adapted to be connected selectively to a reusable handle by a cartridge support structure. The cartridge includes a housing having a plurality of razor blades, each having a sharpened cutting edge. Other modern safety razors have a handle and a razor cartridge that are intended to be permanently coupled and disposed of as a single unit.

There have been many proposals to provide a safety razor having a razor cartridge in fluid communication with a reservoir adapted to store a non-solid shaving aid. Up to now, such razors have not been successfully commercialized or at least not manufactured on a scale that is significant in a mass market such as that of safety razors.

### SUMMARY

One aspect of this disclosure includes a safety razor having a handle adapted to support a razor cartridge and a razor cartridge mounted to the handle. The razor cartridge includes a reservoir assembly and a cartridge assembly that defines a shave plane and is adapted to move with relation to the reservoir assembly during normal shaving operation. A delivery channel connects the reservoir assembly to the cartridge assembly. The reservoir assembly is adapted to contain a non-solid shaving aid. The delivery channel is adapted to allow the non-solid shaving aid to flow between the reservoir assembly and the cartridge assembly during normal shaving operation. The delivery channel is further adapted to undergo an internal volume change that creates a pumping action as the cartridge assembly moves with relation to the reservoir assembly during normal shaving operation.

Another aspect of this disclosure includes a razor cartridge having a reservoir assembly adapted to contain a non-solid shaving aid and a cartridge assembly that defines a shave plane. The cartridge assembly is pivotally attached to the reservoir assembly at one or more pivot points to permit the cartridge assembly to pivot with relation to the reservoir assembly during normal shaving operation. A delivery channel connects the reservoir assembly to the cartridge assembly and is adapted to allow the non-solid shaving aid to flow between the reservoir assembly and the cartridge assembly during normal shaving operation. The delivery channel is further adapted to undergo an internal volume change as the cartridge assembly pivots with relation to the reservoir assembly during normal shaving operation.

These and other features and will be more fully understood with reference to the following detailed description when taken in conjunction with the accompanying drawings.

### BRIEF DESCRIPTION OF THE DRAWINGS

FIG. 1 is an isometric view of an embodiment of a safety razor with a razor cartridge in its neutral position.

FIG. 2A is a cutaway view of an embodiment of a razor cartridge.

FIG. 2B is a cutaway view of another embodiment of a razor cartridge.

FIG. 2C is a cutaway view of another embodiment of a razor cartridge.

FIG. 2D is a cutaway view of a further embodiment of a razor cartridge.

FIG. 3A is a view of an embodiment of a razor cartridge in its neutral position.

FIG. 3B is a view of an embodiment of a razor cartridge in its flexed position.

FIG. 4 is an exploded view of an embodiment of a razor cartridge.

FIG. 5A is a view of an alternate embodiment of a razor cartridge in its neutral position.

FIG. 5B is a view of an alternate embodiment of a razor cartridge in its flexed position.

### DETAILED DESCRIPTION

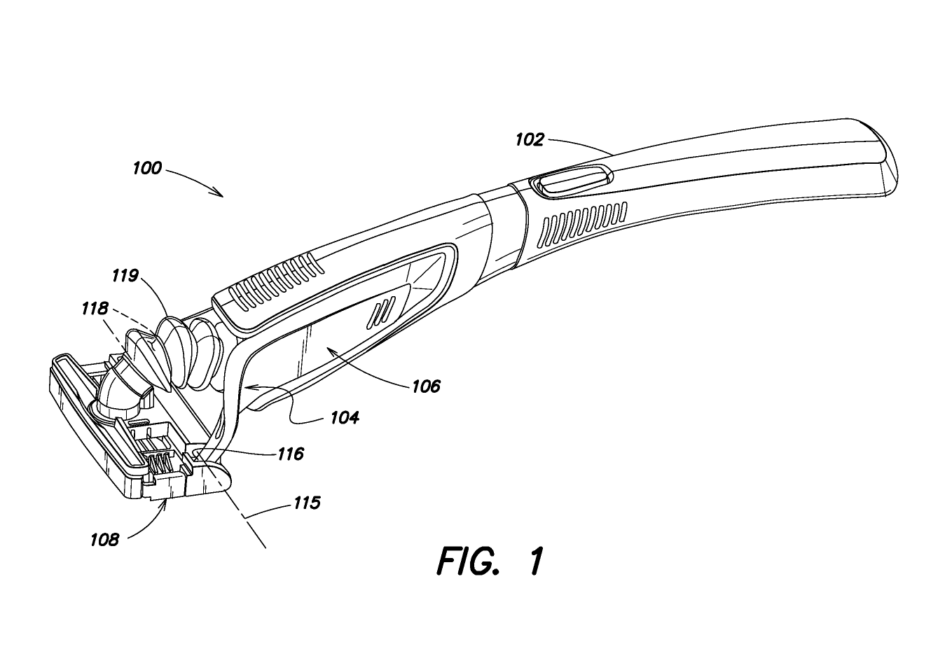

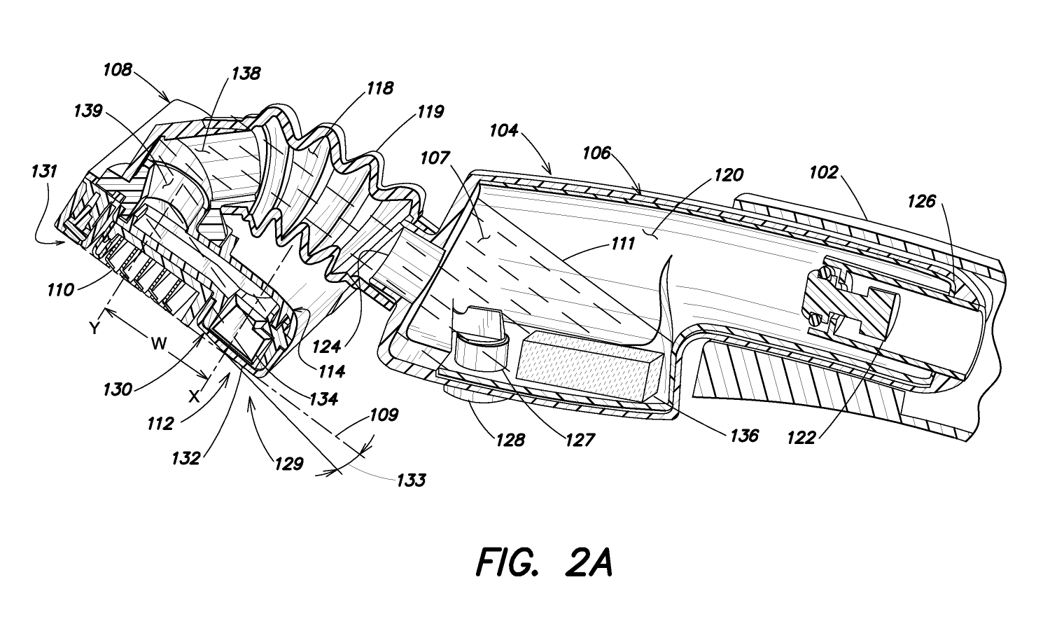

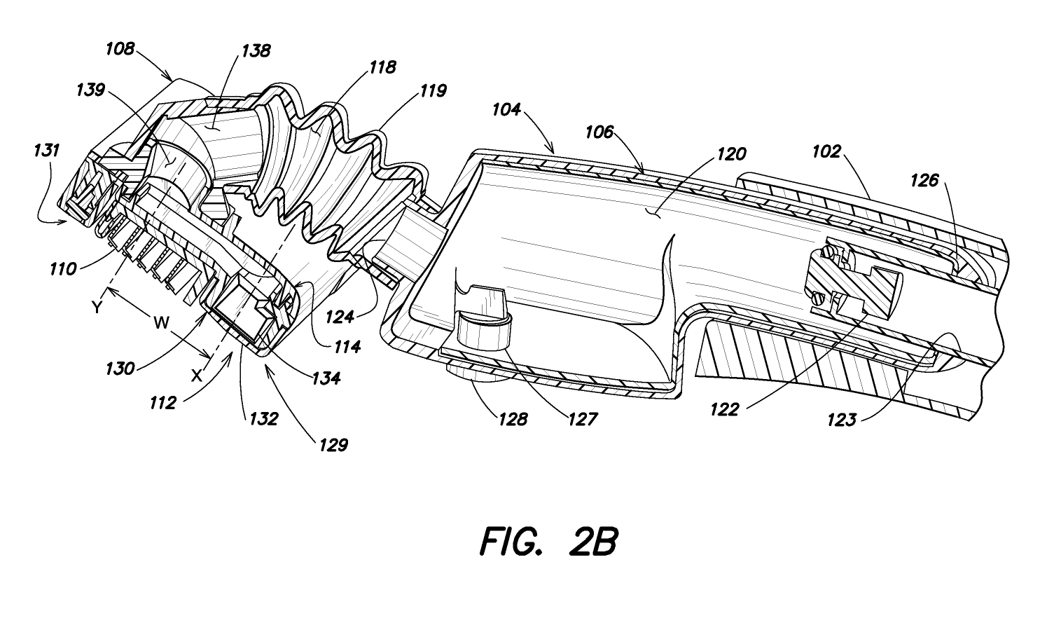

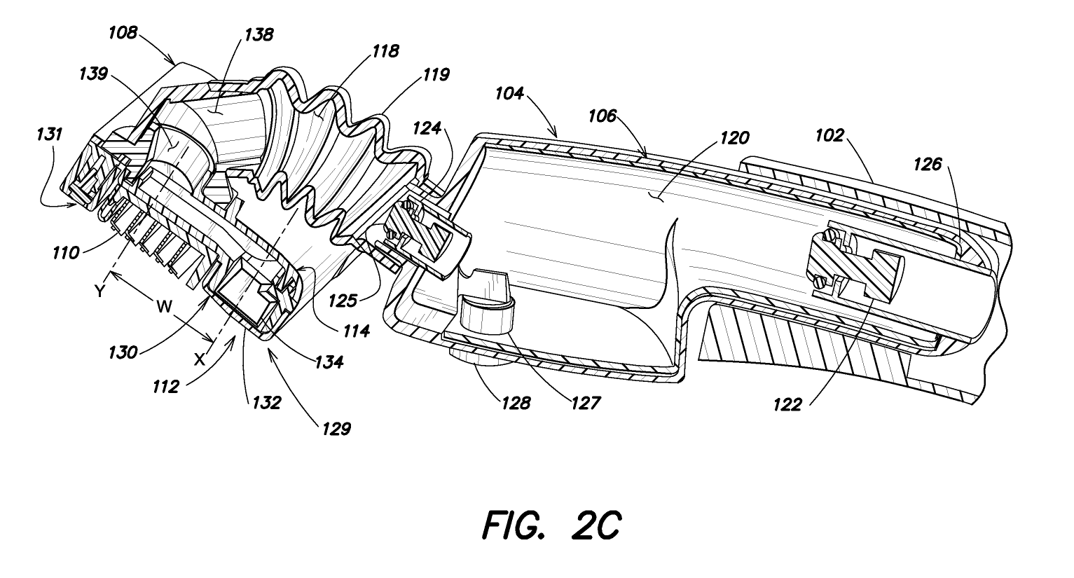

FIG. 1 depicts one embodiment of a safety razor 100 of the present disclosure. The safety razor 100 has a handle 102 adapted to support a razor cartridge 104 that is mounted to the handle 102. The razor cartridge 104 includes a reservoir assembly 106 and a cartridge assembly 108. The cartridge assembly 108 defines a shave plane 109 extending through the cutting edge(s) of the razor blades 110 (see FIG. 2A) and optionally approximately tangentially to an adjacent skin engaging surface 112 (e.g., a cap or a guard) on the housing 114. The cartridge assembly 108 is adapted to move with relation to the reservoir assembly 106 during normal shaving operation. In the embodiment of FIG. 1, the cartridge assembly 108 is pivotally attached to the reservoir assembly 106 to permit the cartridge assembly 108 to pivot with relation to the reservoir assembly 106 along at least one pivot axis 115 during normal shaving operation. For example, a pivot axis may be defined by one or more pivot points 116. A delivery channel 118 connects the reservoir assembly 106 to the cartridge assembly 108. The reservoir assembly 106 is adapted to contain a non-solid shaving aid 107 (and wherein the level 111 of the non-solid shaving aid is dependent upon the attitude of the safety razor 100 and the proportion of the non-solid shaving aid 107 within the reservoir assembly 106). The delivery channel 118 is adapted to allow the non-solid shaving aid to flow between the reservoir assembly 106 and the cartridge assembly 108 during normal shaving operation so that the reservoir assembly 106 is in fluid communication with the cartridge assembly 108. The delivery channel 118 is adapted to undergo an internal volume change as the cartridge assembly 108 moves with relation to the reservoir assembly 106 during normal shaving operation. The internal volume change creates a pumping action that assists in delivering the non-solid shaving aid from the reservoir assembly 106 to the cartridge assembly 108. In this way energy from the normal shaving operation that causes the cartridge assembly 108 to move with relation to the reservoir assembly 106 is used to assist in delivering the non-solid shaving aid to the skin of the user. By “normal shaving operation,” we mean the way an ordinary user would use the safety razor 100 of this disclosure to perform a routine shaving operation on a skin surface, including but not limited pre-shaving operations such as razor preparation, skin preparation, and other pre-shaving operations, hair cutting operations such as skin stroking, razor rinsing, and other hair cutting operations, and post shaving operations such as razor rinsing, razor storage, and other post-shaving operations. The skin surface may be any of the hair-containing skin surfaces that an ordinary user would typically shave, including a face, legs, underarms, and other hair-containing skin surfaces. By “neutral position,” we mean the position the cartridge assembly 108 assumes relative to the reservoir assembly 106 when the safety razor 100 is not in use. The “neutral position” may also be referred to as an “equilibrium position,” “rest position,” or by other terms and generally reflects a stable, engineered position that the cartridge assembly 108 assumes when there is no shaving load.

Still referring to FIG. 1, the razor cartridge 104 is preferably mounted to the handle 102 such that the reservoir assembly 106 is in a fixed relationship with the handle 102 during normal shaving operation. That means that the reservoir assembly 106 does not pivot or otherwise move in relation to the handle 102. Preferably, the combination of the handle 102 and reservoir assembly 106 will provide a stable structural support for the razor cartridge 104 through the normal shaving operation. A person of ordinary skill in the art will recognize that the reservoir assembly 106 may be attached to the handle 102 in a variety of ways. For example, the reservoir assembly 106 may attach to the handle 102 with a snap fit, press fit, detent, hook attachment, friction fit, or other attachment means that would be known to a person of ordinary skill in the art. The reservoir assembly 106 can also be integrally formed with the handle 102. Preferably, at least one portion (preferably a transparent portion) of the reservoir assembly 106 will be visible when the razor cartridge 104 is mounted to the handle 102 so the volume of non-solid shaving aid in the reservoir assembly 106 is visible to the user.

The present disclosure encompasses embodiments directed to a razor 100 with a reusable handle 102 and disposable razor cartridge 104 and embodiments in which the handle 102 is integrated with the razor cartridge 104 to create a disposable razor (i.e., both the handle 102 and razor cartridge 104 are disposed of at the end of the razor cartridge's 104 service life). In one embodiment of a disposable razor (not shown), the reservoir assembly 106 could function both as a reservoir assembly 106 and as a handle 102. A person of ordinary skill in the art will recognize that other embodiments that include a reusable handle 102 or are directed to a disposable razor are possible.

As shown in FIG. 2A, the reservoir assembly 106 of razor cartridge 104 includes a reservoir 120 and, optionally, a valve assembly 122. The reservoir 120 may be a rigid structure and may be deformable or non-deformable. The interior of the reservoir 120 is not pressurized above atmospheric pressure and is intended to remain at substantially atmospheric pressure during normal shaving operation. The valve assembly 122 is designed to permit air to flow into the reservoir 120 during normal shaving operation to fill the volume previously occupied by the non-solid shaving aid during the delivery of the non-solid shaving aid through the delivery channel 118 to the cartridge assembly 108 so the interior of the reservoir 120 remains at substantially atmospheric pressure. A person of ordinary skill in the art will recognize that the pressure in the interior of the reservoir 120 will vary somewhat during operation as the non-solid shaving aid is delivered through the delivery channel 118 to the cartridge assembly 108 including periods of negative pressure that creates sufficient pressure differential between the interior of the reservoir 120 and the ambient surroundings to provide the opening or cracking pressure needed to open the valve assembly 120. Preferably, the valve assembly 122 will have a low opening or cracking pressure to permit air to flow into the reservoir 120 to restore the interior of the reservoir 120 to substantially atmospheric pressure. For example, the valve assembly 122 may have an opening or cracking pressure of about 0.15 psi (1.0 kPa) or less (such as 0.14 psi, 0.13 psi, 0.12 psi, 0.11 psi, 0.10 psi, 0.09 psi, 0.08 psi, 0.07 psi, and so forth or 0.9 kPa, 0.8 kPa, 0.7 kPa, 0.6 kPa, 0.5 kPa, and so forth). Additionally, the valve assembly will restrict the flow of non-solid shaving aid from the reservoir 120 through the valve assembly 122 at all times so that the non-solid shaving aid does not leak from the reservoir 120. A person of ordinary skill in the art will know how to balance a desired low opening or cracking pressure with the desire to prevent the non-solid shaving aid from leaking from the reservoir 120 when designing the valve assembly 122. One source for a suitable valve assembly 122 is Smart Products (Morgan Hill, Calif.). For example, a model 110 check valve from Smart Products having an outer diameter of 0.250 inches (6.35 mm), a body length of 0.392 inches (9.96 mm), a spring rating (i.e., opening or cracking pressure) of 0.11 psi (0.78 kPa) with a polycarbonate body and Buna-N O-ring may be suitable for the valve assembly 122. A person of ordinary skill in the art will know how to select a suitable valve assembly 122 based on the requirements of the razor 100.

Still referring to FIG. 2A, the reservoir 120 has a fluid delivery portion 124 and a rear portion 126. The fluid delivery portion 124 is adapted to permit the non-solid shaving aid to flow from the reservoir 120 into the delivery channel 118. In one embodiment, the valve assembly 122 is positioned on the rear portion 126 of the reservoir 120. In other embodiments, the valve assembly 122 may be positioned on other portions of the reservoir 120 so long as the valve assembly 122 functions as described above.

In other embodiments, the valve assembly 122 may be located on the handle 102 rather than on the reservoir 120. For example, FIG. 2B shows a reservoir assembly 106 of razor cartridge 104 that includes a reservoir 120. Vent port 123 extends from the handle 102 into the reservoir 120 and houses valve assembly 122. A suitable seal 170, e.g. an O ring, can be provided between the vent port and the reservoir. As in the embodiment discussed above, the valve assembly 122 is designed to permit air to flow into the reservoir 120 through vent port 123 during normal shaving operation to fill the volume previously occupied by the non-solid shaving aid during the delivery of the non-solid shaving aid through the delivery channel 118 to the cartridge assembly 108. Preferably, the valve assembly 122 will have a low opening or cracking pressure to permit air to flow into the reservoir 120 through vent port 123. Additionally, the valve assembly will restrict the flow of non-solid shaving aid from the reservoir 120 through the vent port 123 and the valve assembly 122 at all times so that the non-solid shaving aid does not leak from the reservoir 120. A person of ordinary skill in the art will know how to design the interface between the vent port 123 and the reservoir 120, including a suitable seal 170 if desired, and how to balance a desired low opening or cracking pressure with the desire to prevent the non-solid shaving aid from leaking from the reservoir 120 when designing the handle 102 with its vent port 123 and valve assembly 122.

In embodiments in which the valve assembly 122 is located on the handle 102, the opening of the reservoir that mates with vent port 123 may be fitted with a pre-use seal. For clarity of depiction, a seal is not shown in this figure but another seal is shown in FIG. 2D and described later in the present disclosure. The seal prevents the non-solid shaving aid from leaking from the reservoir 120 before the razor cartridge 104 is attached to the handle 102 for use. In such an embodiment, the handle may include means for puncturing the pre-use seal at the time the razor cartridge 104 is attached to the handle 102 to establish fluid communication between the reservoir 120, the vent port 123, and the valve assembly 122. The puncturing means may be a structure that is part of the valve assembly 122 or may be a separate structure (see also FIG. 2D).

Optionally, as shown in FIG. 2C, the reservoir 120 may include a delivery check valve 125 positioned between the fluid delivery portion 124 and the delivery channel 118. The delivery check valve 125 is adapted to permit the non-solid shaving aid to flow into the delivery channel 118, for example when the razor cartridge 104 is inverted during normal shaving operation to rinse the razor blades 110. The delivery check valve 125 may then prevent non-solid shaving aid in the delivery channel 118 from flowing back into the reservoir 120 when the razor cartridge 104 is returned to a shaving position as part of a normal shaving operation after the razor blades 110 are rinsed. The presence of non-solid shaving aid in the delivery channel 118 facilitates the delivery non-solid shaving aid to the cartridge assembly 108 during normal shaving operation. It may be desirable for the delivery check valve 125 to have a lower opening or cracking pressure than the valve assembly 122. A person of ordinary skill in the art will know how to select a suitable delivery check valve 125 based on the requirements of the razor 100.

As also shown in FIG. 2A, the reservoir 120 may optionally include a plug 128 to facilitate filling of the reservoir 120 with non-solid shaving aid through fill port 127. The plug 128 may be removable to expose fill port 127 to permit non-solid shaving aid to be added to the reservoir 120. Alternately, the plug 128 may be fixed but permit non-solid shaving aid to be added to the reservoir with a syringe (not shown) or similar device. A person of ordinary skill in the art will know how to design a plug 128 and fill port 127 to facilitate filling of the reservoir 120 with non-solid shaving aid.

Continuing with FIG. 2A, the cartridge assembly 108 further comprises an applicator 130 adapted to deposit the non-solid shaving aid on a skin surface (not shown) of a user (not shown) during normal shaving operation. The applicator 130 may be in the guard region 129 of the cartridge assembly 108, i.e. positioned to contact a user's skin in advance of the razor blades 110. Optionally, the applicator may be positioned after the razor blades 110 in the cap region 131 of the cartridge assembly 108 instead of or in addition to the guard region 129. In another embodiment (not shown), the applicator 130 may also be positioned between groups of blade(s) 110. As a result, the present disclosure should not be considered limited regarding the location of the applicator 130 on the cartridge assembly 108.

FIG. 2A shows that applicator 130 may comprise an outer layer 132 of a hydrophobic material and an inner body 134 of an oleophilic material. The hydrophobic material may be a non-woven material. The oleophilic material may be a fiber pad. Preferably, the fiber pad comprises spun polyester/polyamide. As a part of the outer layer 132 is in contact with a user's skin during normal shaving operation, the outer layer 132 may be selected to feel soft to the user while resisting abrasion from rubbing contact with the user's skin over the useful life of the razor cartridge 104. In addition, the outer layer 132 should be capable of functioning as a skin stretching element during normal shaving operation to set up the user's hair and skin for contact with the razor blades 110. One example of a suitable material for the outer layer 132 is a spun polyester/polyamide such as Evolon® fabric, particularly Evolon® 170 fabric provided by Freudenberg & Co. (Weinheim, Germany). The spun polyester/polyamide material may optionally be treated, for example by a surface treatment to increase its hydrophobic nature. Suitable treatments are acetic acid or Nuva® 2110 liquid provided by Clariant International Ltd. (Muttenz, Switzerland). Nuva® 2110 liquid is a laundry air dry and low curing fluorocarbon for finishing and technical textile applications. One example of a suitable oleophilic material for the inner body 134 is melt-blown polypropylene fiber.

During use of the safety razor 100, the inner body 134 of the applicator 130 is in fluid communication with the reservoir 120 and will absorb non-solid shaving aid, such as a liquid oil, from the reservoir 120 to become substantially saturated by the non-solid shaving aid. The outer layer 132 provides a soft yet durable surface to resist abrasion of the applicator from sliding contact with the skin surface of a user over the useful life of the razor cartridge 104 while transferring oil from the inner body 134 to the user's skin surface. As discussed above, the outer layer 132 should additionally be capable of functioning as a skin stretching element during normal shaving operation to set up the user's hair and skin for contact with the razor blades 110. The hydrophobic nature of the outer layer 132 resists the infiltration of environmental water to the inner body 134. While it is preferred that no environmental water passes through the outer layer 132 to the inner body 134, it may be acceptable for a small about of water to do so. The inner body 134, being substantially saturated with non-solid shaving aid, such as a liquid oil, resists the infiltration of environmental water that might pass through the outer layer 132 to the inner body 134 and to the reservoir 120. While it is preferred that no environmental water passes through the inner body 134 to the reservoir 120, it may be acceptable for a small about of water to do so.

Alternately, the applicator 130 may comprise for example a wick or a manifold having an array of apertures as disclosed in U.S. Pat. No. 5,134,775 incorporated herein for reference for disclosure relating to elements and features for the application of a non-solid shaving aid. The applicator 130 also may comprise for example a wick overlying a storage medium as disclosed in U.S. Pat. No. 6,886,254 incorporated herein for reference for disclosure relating to elements and features for the application of a non-solid shaving aid. The applicator 130 also may comprise for example an array of valves or an array of rollers disclosed in U.S. Pat. No. 7,043,841 and U.S. Patent application 2005/138814 respectively, both incorporated herein for reference for disclosure relating to elements and features for the application of a non-solid shaving aid.

FIG. 2A shows that the outer layer 132 of the applicator 130 is angled relative to the shave plane 109 at an angle 133. Preferably, the outer layer 132 of the applicator 130 is angled inward relative to the shave plane 109. The outer layer 132 can also be curved or have another non-planar form. Commonly assigned pending U.S. patent application 61/578333 filed on 21 Dec. 2011 is incorporated herein for reference relating to elements and features for the applicator 130 and related structures.

As shown in FIG. 2A, some embodiments of the present disclosure may include a water absorbing body 136 positioned the reservoir 120. The water absorbing body 136 may comprise an oleophobic and hydrophilic fiber material that resists absorption of the oil of the reservoir 120 (as a result of its oleophobic nature) while absorbing and retaining any environmental water that might infiltrate into the reservoir 120 (as a result of its hydrophilic nature). As a result, the water absorbing body 136 helps reduce emulsification or dilution of the oil in the reservoir 120. An example of a suitable material for the water absorbing body 136 is Evolon® 130 also provided by Freudenberg & Co. The Evolon® 130 material can include a surface treatment such as Hydroperm® T or Nuva® N4118 also provided by Clariant International Ltd. to provide suitable oleophobic and hydrophilic characteristics for the water absorbing body 136. Additionally, the water absorbing body 136 may be treated with a fungicide, bactericide, and/or any other treatment known to a person of ordinary skill in the art.

The non-solid shaving aid contemplated by this disclosure may be any non-solid shaving aid presently known or later developed that would be beneficial to use during normal shaving operation. For example, the non-solid shaving aid may be one or more of a lubricating agent, a drag reducing agent (for example, a non-ionic polyacrylamide; and/or a natural polysaccharide derived from plant materials such as “guar gum”), a depilatory agent, a cleaning agent (for example, a silicon polyethylene oxide block copolymer and detergent such as sodium lauryl sulphate), a medicinal agent (for example, for killing bacteria or repairing skin damage and abrasions), a cosmetic agent (for example, for softening, smoothing, conditioning, or improving the skin), a blood coagulant agent (for example, for suppressing bleeding that occurs from nicks and cuts), an astringent agent (for example, for constricting blood vessels to stem the flow of bodily fluids such as lymph, which can exude from skin that has been irritated during shaving), a hydrolysing agent, an anti-irritation agent, agents that provide heating or cooling sensations, or any other non-solid shaving aid than may enhance the shaving process.

Among the benefits that some users have identified for non-solid shaving aids are reduced razor burn, reduced pore clogging, improved moisturization, other skin benefits, post-shave benefits, improved lubricity (results in fewer nicks and cuts), suitability for compact packaging, allowing users to see where they are shaving, and other benefits. Preferably, the non-solid shaving aid comprises a liquid oil, such as a vegetable oil, a silicone oil, an essential oil, or a blend of vegetable oils, silicone oils, and/or essential oils. Examples of such vegetable oils include jojoba oil, grape seed oil, sunflower oil, sweet almond oil, apricot oil and olive oil. It may be desirable for the liquid oil to have a kinematic viscosity of about 20 cSt to about 40 cSt.

In some embodiments, the delivery channel 118 is adapted to impart a restoring (i.e., biasing) force to the cartridge assembly 108 to restore (i.e., bias) the cartridge assembly 108 to a neutral position when the safety razor 100 is not in use. In other embodiments (not shown), an alternate restoring or biasing means may be used to restore or bias the cartridge assembly 108 to a neutral position when the safety razor 100 is not in use. A person of ordinary skill in the art will know of alternate restoring or biasing means that can be used to accomplish this purpose. For example, the alternate restoring or biasing means may be a spring positioned in various locations to restore or bias the cartridge assembly 108 to a neutral position when the safety razor 100 is not in use. If the delivery channel 118 is adapted to restore or bias the cartridge assembly 108 to a neutral position when the safety razor 100 is not in use, the restoring or biasing force may be the result of the material used to form the delivery channel 118 and the design of the delivery channel 118. Alternately, the restoring or biasing action of the delivery channel 118 may be provided by or supplemented with a spring disposed inside or surrounding the delivery channel 118.

As discussed above, the delivery channel 118 may be any structure adapted to undergo an internal volume change as the cartridge assembly 108 moves with relation to the reservoir assembly 106 during normal shaving operation to create a pumping action that assists in delivering the non-solid shaving aid from the reservoir assembly 106 to the cartridge assembly 108. For example, the delivery channel 118 may be a flexible tube, a telescoping or nesting structure, a rolling or spherical diaphragm, or any other structure that provides the desired function. In one embodiment, the delivery channel 118 includes a bellows portion 119 as shown in the FIGS. 1, 2A. As the cartridge moves during ordinary use, the delivery channel 118 alternately compresses and expands in an arc concentric with the pivot axis 115. The repetitive change in volume of the delivery channel 118 resulting from the alternate compression and expansion creates a pumping action. The pumping action provides a motive force for moving the non-solid shaving aid from the reservoir 120 through the delivery channel 118 to the cartridge assembly 108. A person of ordinary skill in the art would know how to design an appropriate delivery channel 118 with bellows portion 119 to provide the desired functionality, including delivery of a desired volume of non-solid shaving aid at a desired flow rate.

Preferably, the delivery channel 118 is made from a material that will survive repeated compression and expansion cycles and contact with the non-solid shaving aid for the entire service life of the razor cartridge 104. For example, the delivery channel 118 may be formed from a silicone material or a fluoropolymer elastomer. One class of materials that may be suitable for use in manufacturing the delivery channel 118 includes materials available from E. I. du Pont de Nemours and Company (Wilmington, Del.) under the Viton® brand name. A person of ordinary skill in the art will appreciate that other materials also may be acceptable. The delivery channel 118 may be made according to any appropriate method known in the art now or in the future.

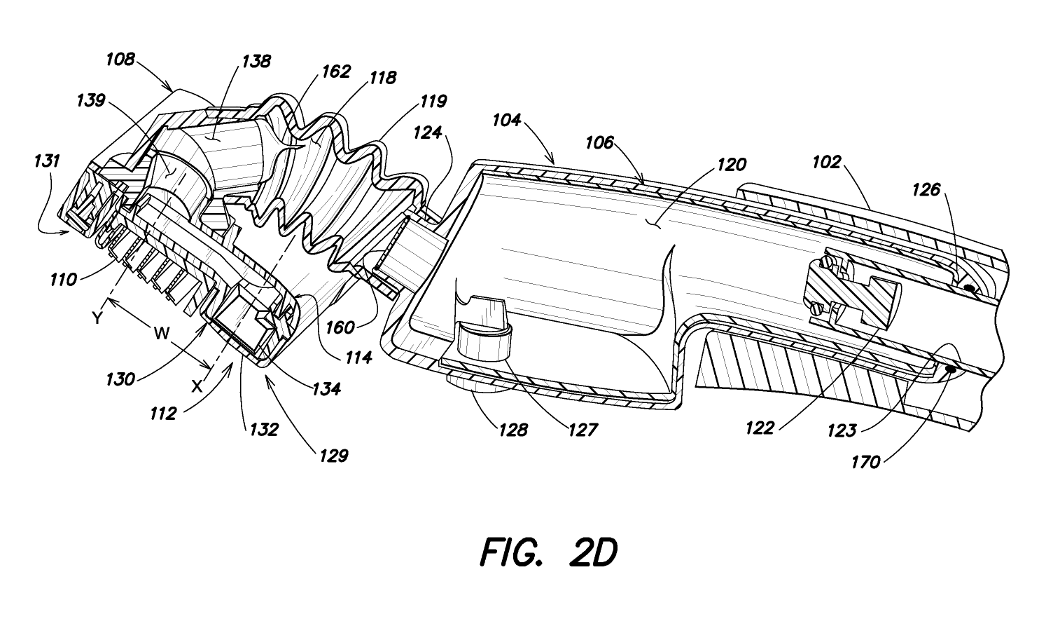

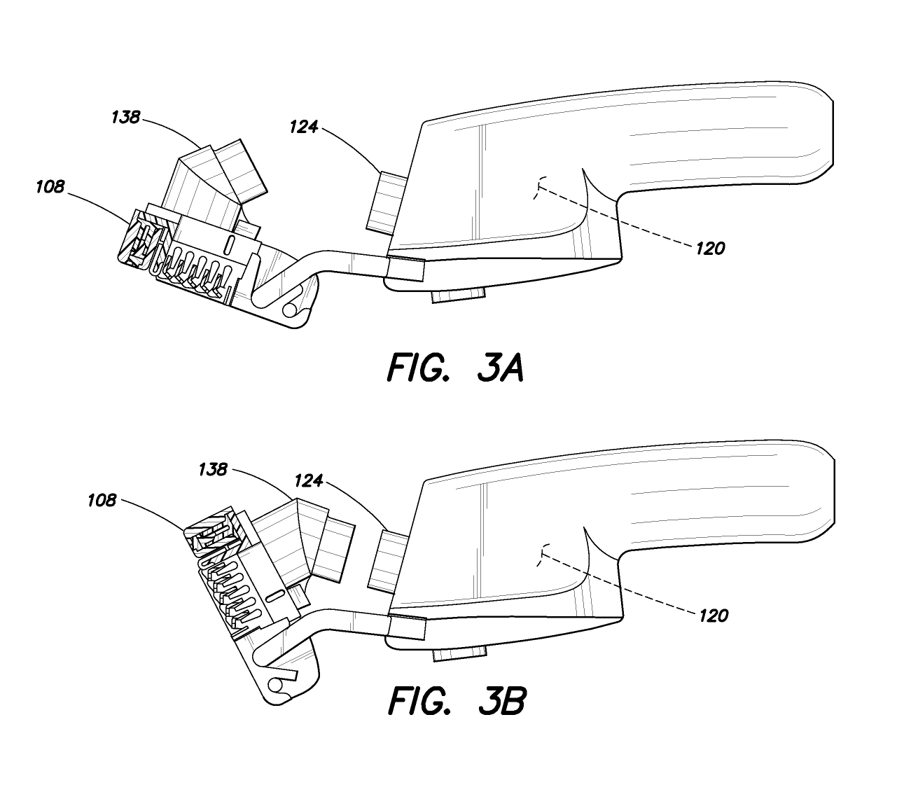

FIG. 3A shows the cartridge assembly 108 in a neutral position relative to the reservoir assembly 106. The delivery channel 118 is not shown in either FIG. 3A or in FIG. 3B to highlight the action of a fluid elbow 138 relative to the fluid delivery portion 124 of the reservoir 120. Preferably, as shown in FIG. 3B, the fluid elbow 138 is directly in line with the fluid delivery portion 124 when the cartridge assembly 108 moves fully from its neutral position (FIG. 3A) to a fully flexed position (FIG. 3B). In the embodiments in which the delivery channel 118 is adapted to restore or bias the cartridge assembly 108 as discussed above, the delivery channel 118 urges the cartridge assembly 108 back to its neutral position once the forces generated during a normal shaving operation are diminished or removed. Optionally, the safety razor 100 may be fitted with a set off device (not shown) such as feet or any other support structure to limit the extent to which the applicator 130 comes in contact with on surface onto which the safety razor 100 may be place before, during, or after use. Such a set off device may be formed on the handle 102 or razor cartridge 104 as desired.

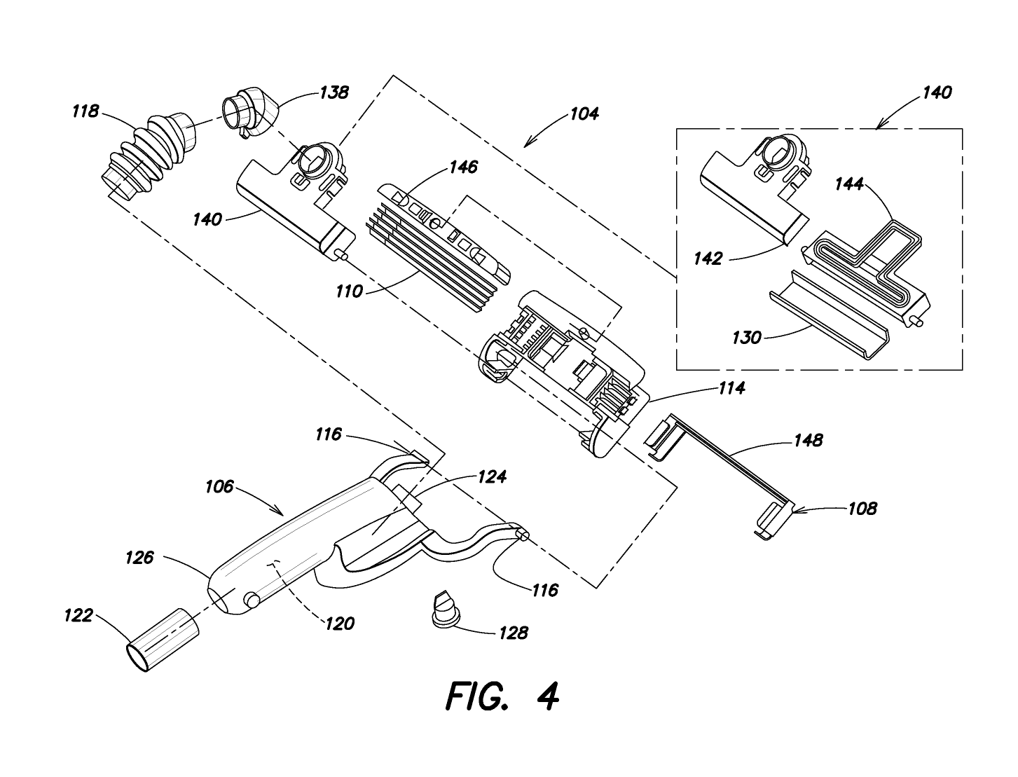

FIG. 4 shows an exploded view that provides additional details of one embodiment of the razor cartridge 104. As discussed previously, a reservoir assembly 106 includes a reservoir 120, a valve assembly 122, a fluid delivery portion 124, a rear portion 126, and a plug 128. Pivot points 116 provide locations for the cartridge assembly 108 to pivotally attach to the reservoir assembly 106. A delivery channel 118 connects the reservoir assembly 106 to the cartridge assembly 108 through the fluid delivery portion 124 and a fluid elbow 138. A fluid distributor assembly 140, razor blades 110, a housing 114, and a lube box assembly 146, engage with a clip 148 to form the cartridge assembly 108. The fluid distributor assembly in turn includes a fluid distributor base 142, a fluid distributor 144, and an applicator 130.

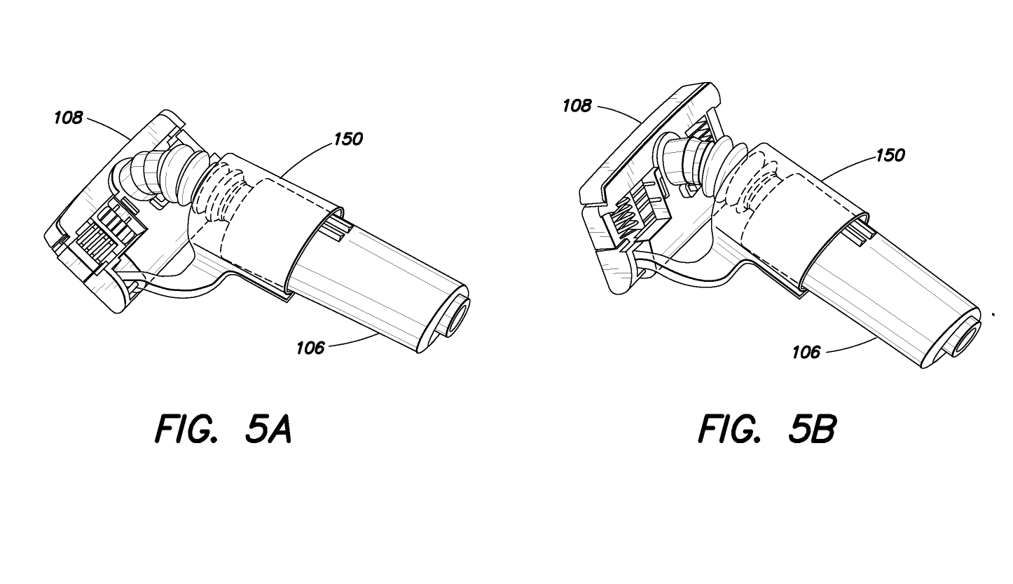

FIGS. 5A and 5B depict an alternate embodiment in which the cartridge assembly 108 is not directly attached to the reservoir assembly 106. Rather, the cartridge assembly 108 is pivotally attached to an intermediate piece 150 and the intermediate piece 150 is attached to the reservoir assembly 106. In one option, the intermediate piece 150 is in a fixed relationship with the reservoir assembly 106 so that the intermediate piece 150 and the reservoir assembly 106 do not move in relation to each other when the cartridge assembly 108 moves during normal shaving operation. In another option, the intermediate piece 150 is in a sliding relationship with the reservoir assembly 106 so that the intermediate piece 150 moves in relation to the reservoir assembly 106 when the cartridge assembly 108 moves during normal shaving option. In this option, as the cartridge assembly 108 moves during normal shaving operation, the intermediate piece 150 moves in relation to the reservoir assembly 106 until coming to rest against an internal stop (not shown) in the intermediate piece 150. At this point, the delivery channel 118 may continue to compress as it undergoes its internal volume change. FIG. 5B shows the delivery channel 118 in its fully compressed position.

Optionally, as shown in FIG. 2D, the end of the fluid delivery portion 124 of the reservoir assembly 106 can be closed by a seal 160. The seal can comprise a metallic foil; a plastic film, e.g. a polyester film; a metallized plastic or other suitable material. The seal prevents accidental leakage of the non-solid shaving aid between manufacture and use by a consumer, e.g. during shipping (e.g. due to environmental changes), long term storage or sale. The seal can also prevent any premature degradation of the non-solid shaving aid e.g. by exposure to air. The outer end wall of the fluid elbow 138 includes a spike 162. The spike 162 can be integrally formed with the fluid elbow 138 or can be separate structure. Upon use of the safety razor the user will move, e.g. pivot (fully or partially) cartridge assembly relative to the reservoir assembly causing the spike 162 to puncture the seal 160 thereby enabling the non-solid shaving aid to flow to the applicator 130.

For any embodiments, whether discussed in this application or not, it may be desirable to size the cartridge assembly 108 and delivery channel 118 to hold a selected volume of non-solid shaving aid during normal shaving operation to expedite delivery of the non-solid shaving aid to the skin surface of the user during normal shaving operation. One way to do this would be to establish a selected offset W between the center line X of the applicator 130 and the center line Y of a fluid inlet port 139 as shown in FIGS. 2A, 2B, 2C. A person of ordinary skill in the art will know how to select the volume of non-solid shaving aid to be held in the cartridge assembly 108 and delivery channel 118 during normal shaving operation. Similarly, a person of ordinary skill in the art will know how to select the offset W or to take other design steps to provide for the selected volume.

While various embodiments have been described above, it should be understood that they have been presented by way of example only, and not limitation. For instance, modifications or changes as can be made within the scope of the attached claims and features disclosed in connection with any one embodiment can be used alone or in combination with each feature of the respective other embodiments. Thus, the breadth and scope of any embodiment should not be limited by any of the above described exemplary embodiments, but should be defined only in accordance with the following claims and their equivalents.

What is claimed is:

1. A safety razor, comprising:
(a) a handle adapted to support a razor cartridge and
(b) a razor cartridge mounted to the handle, comprising:
(a) a reservoir assembly adapted to contain a non-solid shaving aid,
(b) a cartridge assembly that defines a shave plane and is adapted to move with relation to the reservoir assembly during normal shaving operation,
(c) a delivery channel that connects the reservoir assembly to the cartridge assembly, wherein the delivery channel is adapted to allow the non-solid shaving aid to flow between the reservoir assembly and the cartridge assembly during normal shaving operation,
wherein, the delivery channel is further adapted to undergo an internal volume change that creates a pumping action as the cartridge assembly moves with relation to the reservoir assembly during normal shaving operation.

2. The safety razor of claim 1, wherein the razor cartridge is mounted to the handle such that the reservoir assembly is in a fixed relationship with the handle.

3. The safety razor of claim 1, wherein the reservoir assembly further comprises a reservoir and a valve assembly.

4. The safety razor of claim 3, wherein the reservoir has a fluid delivery portion and a rear portion and the valve assembly is positioned on the rear portion.

5. The safety razor of claim 1, wherein the reservoir assembly further comprises a reservoir having a fluid delivery portion, a rear portion, and a vent port positioned on the rear port and wherein the handle includes a valve assembly in fluid communication with the vent port and reservoir.

6. The safety razor of claim 1, wherein the reservoir assembly further comprises a reservoir having a fluid delivery portion and a delivery check valve positioned between the fluid delivery portion and the delivery channel.

7. The safety razor of claim 1, wherein the cartridge assembly is pivotally attached to the reservoir assembly at one or more pivot points to permit the cartridge assembly to pivot with relation to the reservoir assembly during normal shaving operation.

8. The safety razor of claim 1, wherein the non-solid shaving aid comprises a liquid oil.

9. The safety razor of claim 1, wherein the delivery channel is adapted to restore the cartridge assembly to a neutral position when the safety razor is not in use.

10. The safety razor of claim 1, wherein delivery channel includes a bellows portion.

11. The safety razor of claim 7, wherein the delivery channel compresses and expands in an arc concentric with the one or more pivot points.

12. The safety razor of claim 1, wherein the cartridge assembly and delivery channel are sized to hold a selected volume of non-solid shaving aid during normal shaving operation to expedite delivery of the non-solid shaving aid during normal shaving operation.

13. A razor cartridge, comprising:
(a) a reservoir assembly adapted to contain a non-solid shaving aid,
(b) a cartridge assembly that defines a shave plane and is adapted to move with relation to the reservoir assembly during normal shaving operation,
(c) a delivery channel that connects the reservoir assembly to the cartridge assembly, wherein the delivery channel is adapted to allow the non-solid shaving aid to flow between the reservoir assembly and the cartridge assembly during normal shaving operation,
wherein, the delivery channel is further adapted to undergo an internal volume change that creates a pumping action as the cartridge assembly moves with relation to the reservoir assembly during normal shaving operation.

14. The razor cartridge of claim 13, wherein the reservoir assembly further comprises a reservoir with a fluid delivery portion and a rear portion and a valve assembly positioned in the rear portion.

15. The razor cartridge of claim 13, wherein the reservoir assembly further comprises a reservoir having a fluid delivery portion and a delivery check valve positioned between the fluid delivery portion and the delivery channel.

16. The razor cartridge of claim 13, wherein the cartridge assembly is pivotally attached to the reservoir assembly at one or more pivot points to permit the cartridge assembly to pivot with relation to the reservoir assembly during normal shaving operation.

17. The razor cartridge of claim 13, wherein the cartridge assembly is pivotally attached to an intermediate piece in a fixed relationship with the reservoir assembly.

18. The razor cartridge of claim 13, wherein the cartridge assembly is pivotally attached to an intermediate piece in a sliding relationship with the reservoir assembly.

19. The razor cartridge of claim 13, wherein the delivery channel is adapted to restore the cartridge assembly to a neutral position when the safety razor is not in use.

20. The razor cartridge of claim 13, wherein the reservoir assembly includes a seal and the cartridge assembly includes a fluid elbow having a spike adapted to pierce the seal when the cartridge assembly moves with relation to the reservoir assembly.

21. A razor cartridge comprising:
(a) a reservoir assembly adapted to contain a non-solid shaving aid,
(b) a cartridge assembly that defines a shave plane and is pivotally attached to the reservoir assembly at one or more pivot points to permit the cartridge assembly to pivot with relation to the reservoir assembly during normal shaving operation,
(c) a delivery channel that connects the reservoir assembly to the cartridge assembly, wherein the delivery channel is adapted to allow the non-solid shaving aid to flow between the reservoir assembly and the cartridge assembly during normal shaving operation,
wherein, the delivery channel is adapted to undergo an internal volume change by compressing and expanding in an arc concentric with the one or more pivot points as the cartridge assembly pivots with relation to the reservoir assembly during normal shaving operation and the delivery channel is further adapted to restore the cartridge assembly to a neutral position with the razor cartridge is not in use.
